(19) United States
(12) Patent Application Publication
(10) Pub. No.: US 2010/0329336 A1
(43) Pub. Date: Dec. 30, 2010

(54) METHOD AND APPARATUS FOR ENCODING AND DECODING BASED ON INTER PREDICTION USING IMAGE INPAINTING

(75) Inventors: Yu-Mi Sohn, Seoul (KR); Jung-Hye Min, Yongin-si (KR); Woo-Jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/918,688

(22) PCT Filed: Feb. 20, 2009
(86) PCT No.: PCT/KR2009/000822

§ 371 Date: Aug. 20, 2010

(30) Foreign Application Priority Data
Feb. 20, 2008 (KR) 10-2008-0015451

(51) Int. Cl. H04N 7/50

(52) U.S. Cl. 375/240.12; 375/E07.211

(57) ABSTRACT

Provided are a method and apparatus for encoding and decoding based on inter prediction. In the method of encoding based on inter prediction, image inpainting is performed by searching for at least one reference picture by using pixels that are adjacent to the boundary between a current block and a previously encoded region of a current picture and are included in the previously encoded region, and the current block is encoded based on a predicted block obtained as the result of performing image inpainting. Accordingly, it is possible to precisely generate a predicted block, thereby improving the compression rate of image encoding.

### CROSS REFERENCE TO RELATED APPLICATIONS

This application is a National Stage application under 35 U.S.C. §371 of PCT/KR2009/000822 filed on Feb. 20, 2009, which claims the benefit of Korean Patent Application No. 10-2008-0015451, filed on Feb. 20, 2008, in the Korean Intellectual Property Office, all the disclosures of which are incorporated herein in their entireties by reference.

### BACKGROUND

1. Field

The exemplary embodiments relate to a method and apparatus for encoding and decoding based on inter prediction, and more particularly, to a method and apparatus for generating a predicted block of a current block by precisely performing inter prediction and then encoding or decoding the current block based on the predicted block.

2. Description of Related Art

In video compression methods, such as MPEG-1, MPEG-2, and MPEG-4H.264/MPEG-4 Advanced Video Coding (AVC), a picture is divided into predetermined sized blocks in order to encode the picture. Next, each of the blocks is encoded using inter prediction and intra prediction. Next, an optimal encoding mode is selected in consideration of rate-distortion (R-D) costs, and the blocks are encoded according to the optimal coding mode.

In methods of encoding an image by using inter prediction, the image is compressed by removing temporal redundancies among pictures, and a representative example of the above methods is a motion estimation-based encoding method. In the motion estimation-based encoding method, an image is encoded by estimating and compensating for the motion of a current picture in units of blocks by using at least one reference picture.

In this case, a reference block most similar to a current block is searched for within a predetermined search range of the reference picture, using a predetermined evaluation function. If the similar reference block is found, only a residual block that is the difference between the current block and the similar reference block in the reference picture is encoded. Here, various-sized blocks, e.g., a 16×16 block, an 8×16, an 8×8 block, and a 4×4 block, may be used as the current block, which will be described in greater detail with reference to FIG. 1.

FIG. 1 is a diagram illustrating a conventional inter prediction method. Referring to FIG. 1, inter prediction is performed based on at least one reference picture when encoding or decoding an image.

In order to inter predict a current block 112 of a current picture 110, an image encoding apparatus searches a reference picture 120 for a reference block 122 most similar to the current block 112. Here, the reference block 122 is a block through which the current block 112 can be most appropriately predicted. A block having a minimum sum of absolute difference (SAD) between the current block 112 and itself may be determined to be the reference block 122.

The reference block 122 is used as a predicted block of the current block 112, and a residual block is generated by subtracting the reference block 122 from the current block 112. Only the residual block is encoded and then is inserted into a bitstream. In this case, the relative difference between the locations of the current block 112 in the current picture 110 and the reference block 122 in the reference picture 120 is referred to as a motion vector 130. The motion vector 130 is encoded together with the residual block.

As illustrated in FIG. 1, a conventional inter prediction-based encoding method, only a residual block is encoded and transmitted in order to increase compression efficiency. Therefore, the more precisely the current block 112 can be predicted, the higher the compression rate of image encoding.

### SUMMARY

The exemplary embodiment provides an inter prediction-based encoding/decoding method and apparatus capable of generating a predicted block by precisely inter predicting a current block by using image inpainting and then encoding/decoding the current block based on the predicted block.

The exemplary embodiment also provides a computer readable medium having recorded thereon a computer program for executing the above method.

According to an aspect of an exemplary embodiment, there is provided an inter prediction-based encoding method comprising performing image inpainting by searching for at least one reference picture by using pixels that are adjacent to the boundary between a current block and a previously encoded region of a current picture and are included in the previously encoded region; generating a predicted block of the current block based on the result of performing image inpainting; and encoding the current block based on the predicted block.

The encoding of the current block may comprise encoding the current block according to a skip mode.

The performing of image inpainting may comprise performing exemplar-based image inpainting by searching for at least one reference picture by using the pixels that are adjacent to the boundary between the current block and the previously encoded region of the current picture and are included in the previously encoded region.

According to another aspect of an exemplary embodiment, there is provided an inter prediction-based encoding apparatus comprising an image inpainting unit performing image inpainting by searching for at least one reference picture by using pixels that are adjacent to the boundary between a current block and a previously encoded region of a current picture and are included in the previously encoded region; a prediction unit generating a predicted block of the current block based on the result of performing image inpainting; and an encoding unit encoding the current block based on the predicted block.

According to another aspect of an exemplary embodiment, there is provided an inter prediction-based decoding method comprising performing image inpainting by searching for at least one reference picture by using pixels that are adjacent to the boundary between a current block and a previously decoded region of a current picture and are included in the previously decoded region; generating a predicted block of the current block based on the result of performing image inpainting; and reconstructing the current block based on the predicted block.

The reconstructing of the current block may comprise reconstructing current block according to a skip mode.

The performing of image inpainting may comprise performing exemplar-based image inpainting by searching for at least one reference picture by using pixels that are adjacent to the boundary between the current block and the previously decoded region of a current picture and are included in the previously decoded region.

According to another aspect of an exemplary embodiment, there is provided a decoding apparatus based on inter prediction, the apparatus comprising an image inpainting unit performing image inpainting by searching for at least one reference picture by using pixels that are adjacent to the boundary between a current block and a previously decoded region of a current picture and are included in the previously decoded region; a prediction unit generating a predicted block of the current block based on the result of performing image inpainting; and a reconstruction unit reconstructing the current block based on the predicted block.

According to the above exemplary embodiments, a current block can be precisely predicted using image inpainting when performing inter prediction, thereby improving the compression rate of image encoding.

### DESCRIPTION OF DRAWINGS

The above and other features will become more apparent by describing in detail exemplary embodiments thereof with reference to the attached drawings in which:

FIG. 1 is a diagram illustrating a conventional inter prediction method;

FIG. 2 is a block diagram of an image encoding apparatus using inter prediction according to an exemplary embodiment;

FIG. 3 is a diagram illustrating the boundary between a current block and a previously encoded region of the current picture, according to an exemplary embodiment;

FIGS. 4A through 4E are diagrams sequentially illustrating an image inpainting method according to an exemplary embodiment;

FIGS. 5A through 5D are diagrams sequentially illustrating inter prediction of a macro block according to an exemplary embodiment;

FIG. 6 is a flowchart illustrating an image encoding method according to an exemplary embodiment;

FIG. 7 is a block diagram of an image decoding apparatus according to an exemplary embodiment; and

FIG. 8 is a flowchart illustrating an image decoding method according to an exemplary embodiment.

### DETAILED DESCRIPTION OF EXEMPLARY EMBODIMENTS

Hereinafter, exemplary embodiments will be described in detail with reference to the accompanying drawings. Hereinafter, an ‘image’ may denote a still image for a video or a moving image, that is, the video itself.

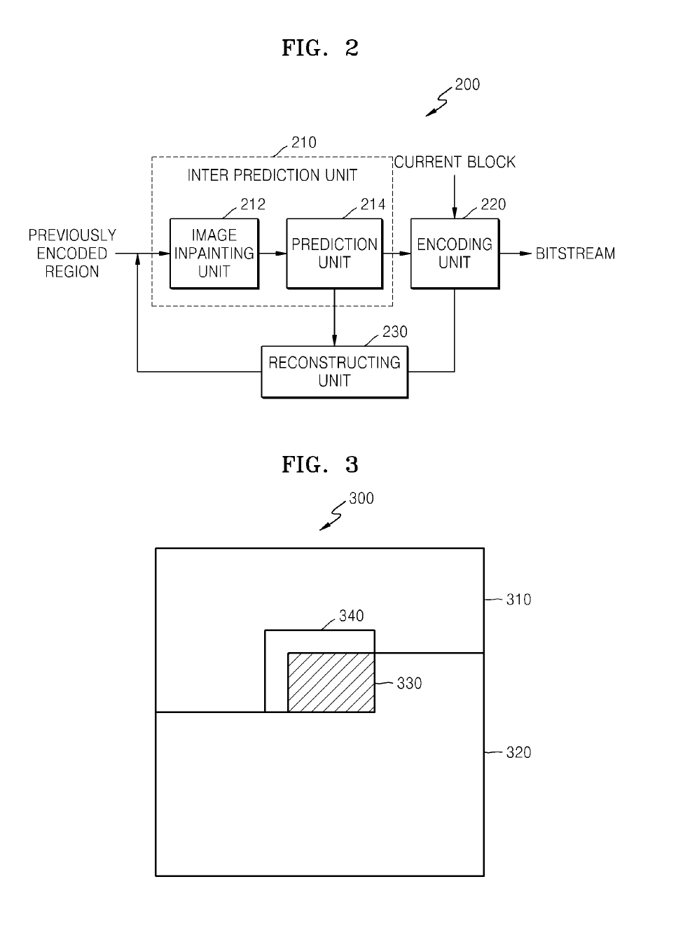

FIG. 2 is a block diagram of an image encoding apparatus 200 using inter prediction according to an exemplary embodiment. Referring to FIG. 2, the image encoding apparatus 200 includes an inter prediction unit 210, an encoding unit 220, and a reconstruction unit 230.

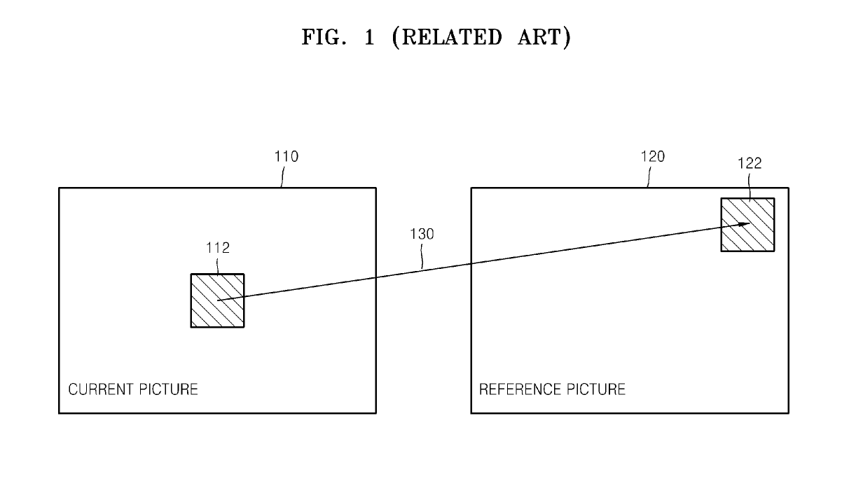

The inter prediction unit 210 generates a predicted block of a current block by inter predicting the current block in order to remove temporal redundancies among pictures. In the current exemplary embodiment, the inter prediction unit 210 provides a new inter prediction mode different than the conventional inter prediction method described above with reference to FIG. 1.

According to the current exemplary embodiment, the current block is inter predicted by performing image inpainting based on pixels included in a previously encoded region of a current picture from among a plurality of pixels adjacent to the boundary between the current block and the previously encoded region, rather than by searching in a reference picture for a reference block most similar to the current block by calculating a sum of absolute difference (SAD).

In order to perform inter prediction according to an exemplary embodiment, the inter prediction unit 210 includes an image inpainting unit 212 and a prediction unit 214, which will now be described in greater detail with reference to FIG. 3.

FIG. 3 is a diagram illustrating the boundary between a current block 330 and a previously encoded region 310 of a current picture 300, according to an exemplary embodiment.

The image inpainting unit 212 illustrated in FIG. 2 performs image inpainting by using a plurality of pixels 340 adjacent to the boundary between the current block 330 and the previously encoded region 310 of the current picture 300. Image inpainting is performed by searching for at least one reference picture, based on the pixels 340.

Image inpainting according to an exemplary embodiment will now be described on an assumption that the size of the current block 330 is 8×8. However, it would be apparent to those of ordinary skill in the art that image inpainting according to the exemplary embodiment can be applied to inter predicting the other various sized blocks, e.g., a 4×4 block, an 8×16 block, a 16×8 block, and a 16×16 block.

The boundary between the current block 330 and the previously encoded region 310 is set as an initial boundary of a region that is to be reconstructed, and then, image inpainting is performed based on the pixels 340 included in the previously encoded region 310 from among the pixels adjacent to the boundary.

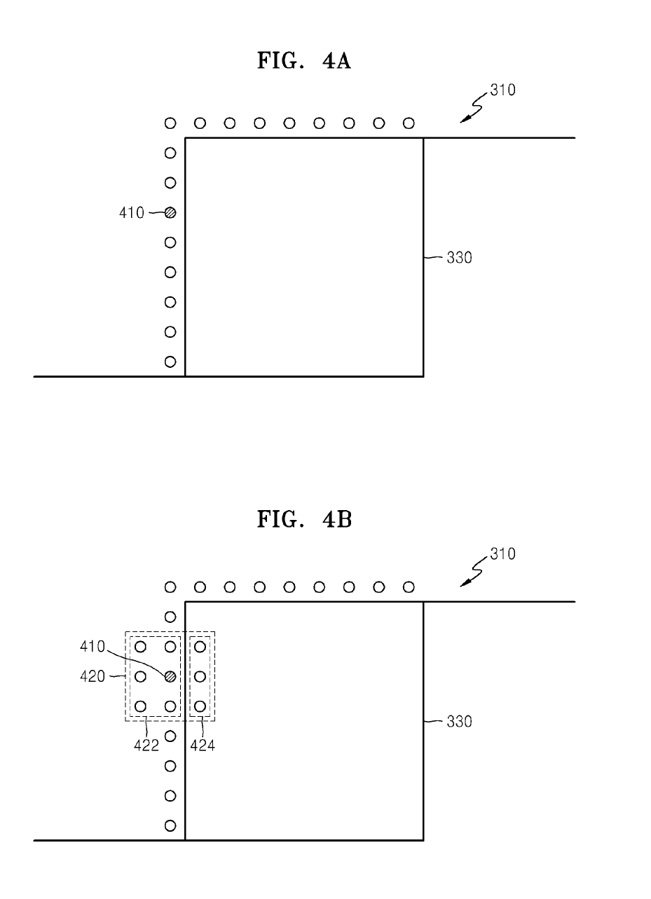

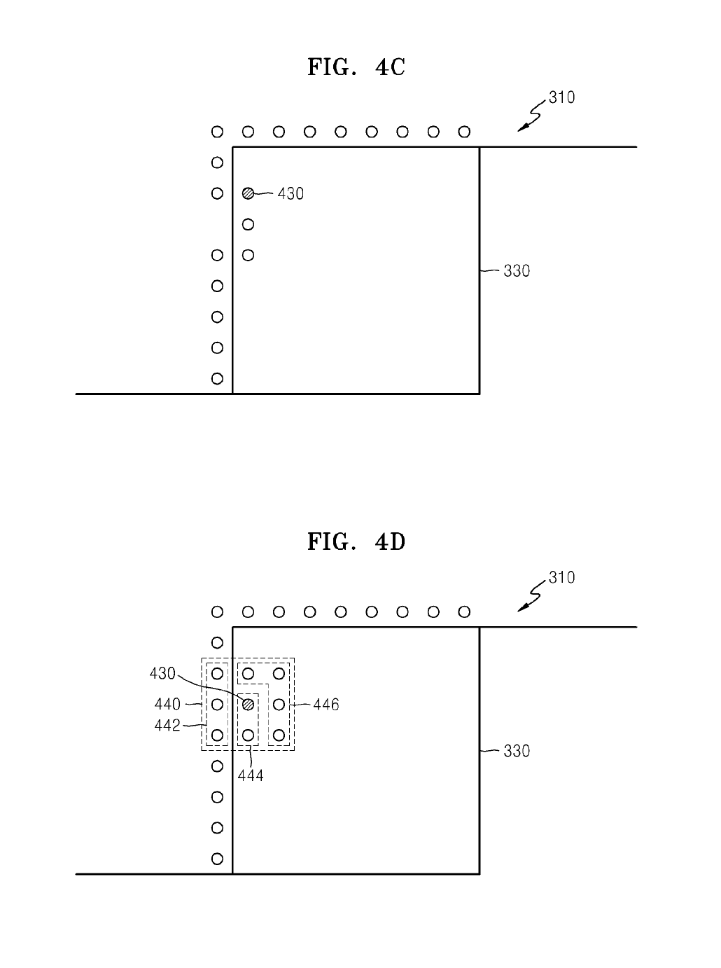

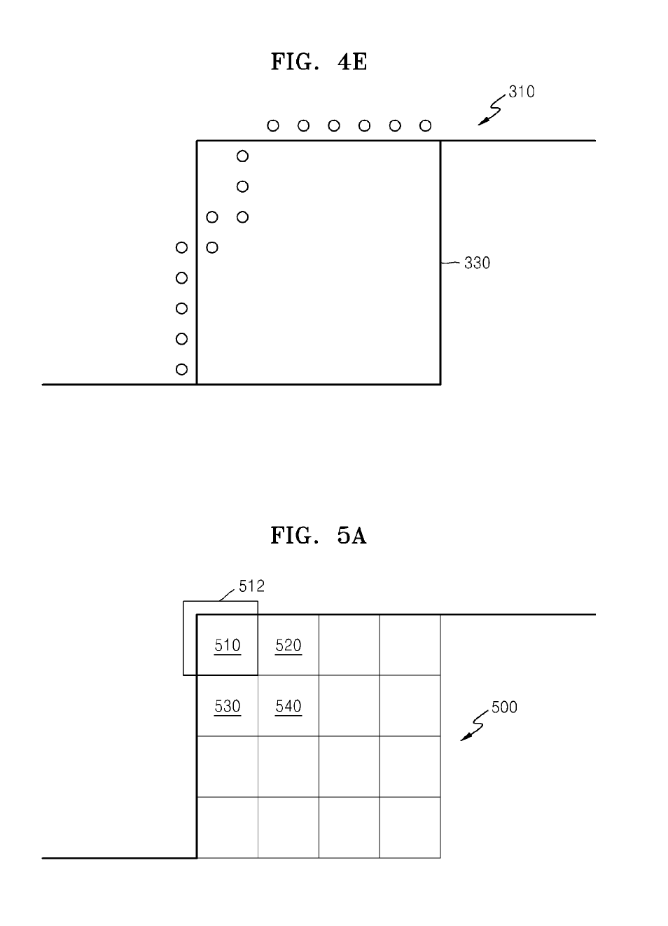

Here, exemplar-based image inpainting may be performed as image inpainting, which will be described in greater detail with reference to FIGS. 4A through 4E.

FIGS. 4A through 4E are diagrams sequentially illustrating an image inpainting method according to an exemplary embodiment. Referring to FIGS. 3 and 4A, in order to predict a current block 330, exemplar-based image inpainting is performed based on pixels 340 included in a previously encoded region 310 from among pixels adjacent to the boundary between the current block 330 and the previously encoded region 310.

First, a pixel 410 having highest priority to be reconstructed is selected from among the pixels 340 adjacent to the boundary between the current block 330 and the previously encoded region 310, which is set as an initial boundary of a region that is to be reconstructed. A pixel having highest priority to be reconstructed may be determined in various ways but may be determined based on the angle between the boundary of a region that is to be reconstructed and an edge direction of each pixel. That is, it is possible to calculate an edge direction of each of the pixels 340, and determine the order of pixels that are to be reconstructed, based on the angles between the edge directions and the boundary of the region that is to be reconstructed. The greater the angle between the boundary of the region that is to be reconstructed and the edge direction of a pixel, the higher the priority of the pixel that is to be reconstructed.

If the pixel 410 having the highest priority is selected, a patch 420 including the pixel 410 and pixels adjacent to the pixel 410 is set as illustrated in FIG. 4B. The patch 420 is a basic unit in which image painting is performed, and may have various sizes, e.g., 3×3, 5×5, or 7×7. The current exemplary embodiment will be described with respect to a case where a 3×3 patch is used.

After setting the patch 420 including the pixel 410 having the highest priority at the center thereof, at least one reference picture is searched for using pixels 422 included in the previously encoded region 310 from among the pixels included in the patch 420. Then, one or more pixels having a minimum SAD between themselves and the pixels 422 from among the pixels included in the patch 420 are searched for from the at least one reference picture. A patch of the reference picture including the searched for pixel(s) is determined to be most similar to the patch 420 illustrated in FIG. 4B.

If the similar patch is found, a part of the current block 330 is reconstructed by copying the values of the other pixels of the similar patch excluding the searched for pixel(s) having the minimum SAD to the other pixels 424 of the patch 420. Referring to FIG. 4B, the values of the pixels 424 in the rightmost column of the patch 420 are values reconstructed using the patch 420.

If first reconstruction of the current block 330 is completed, the boundary of the region that is to be reconstructed is updated based on the reconstructed pixels 424 as illustrated in FIG. 4C. Then, a pixel 430 having highest priority to be reconstructed is selected around the updated boundary.

After the pixel 430 having the highest priority is selected, a patch 440 including the pixel 430 at the center thereof is set as illustrated in FIG. 4D. The patch 440 includes pixels 442 included in the previously encoded region 310, pixels 444 included in the previously reconstructed region, and pixels 446 that are to be reconstructed using the patch 440.

A patch most similar to the patch 440 is found by searching for at least one reference picture by using the pixels 442 and the pixels 444 from among the pixels included in the patch 440. The values of pixels 446 of the patch 440 are reconstructed according to the result of searching.

If second reconstruction of the current block 330 is completed, the boundary of the region that is to be reconstructed is updated again as illustrated in FIG. 4E. Such image inpainting is repeated until all the pixels included in the current block 330 are reconstructed.

In order to facilitate reconstruction, the size of a patch may be increased so that pixels as many as possible can be reconstructed when reconstruction is performed. Also, it is possible to reduce a total number of reference pictures that are to be searched or to restrict a range of searching within a reference picture, using pixels included in a previously encoded region and a previously reconstructed region of the patch 420 or 440.

Referring to FIG. 2, when the image inpainting unit 212 reconstructs all the pixels included in the current block 330, the prediction unit 214 predicts the current block 330 based on the result of reconstructing. A block reconstructed by the image inpainting unit 212 may be directly used as a predicted block of the current block 330.

The encoding unit 220 encodes the current block 330 by using the predicted block generated from prediction performed by the inter prediction unit 210. Then, a discrete cosine coefficient is obtained by performing discrete cosine transform (DCT) on a residual block of the current block 330, and the discrete cosine coefficient is quantized. The quantized discrete cosine coefficient is entropy coded and then is inserted into a bitstream.

When the encoding unit 220 encodes the current block 330 by using the predicted block, encoding may be performed according to a skip mode. The skip mode means an encoding mode in which only encoding mode information representing that the current block 330 has been encoded according to the skip mode is encoded without encoding the residual block of the current block 330. If calculation of rate-distortion (R-D) costs reveals that the current block 330 is, but not necessarily, encoded according to the skip mode, the encoding unit 220 encodes the current block 330 according to the skip mode.

The reconstruction unit 230 reconstructs the residual block by dequantizing and performing inverse DCT on the quantized discrete cosine coefficient. The reconstructed residual block is combined with the predicted block generated by the prediction unit 214, thereby reconstructing the current block 330. The reconstructed current block 330 is used in order to predict another block. If the current block 330 is reconstructed according to the skip mode, the predicted block generated by the prediction unit 214 is directly used in order to predict another block.

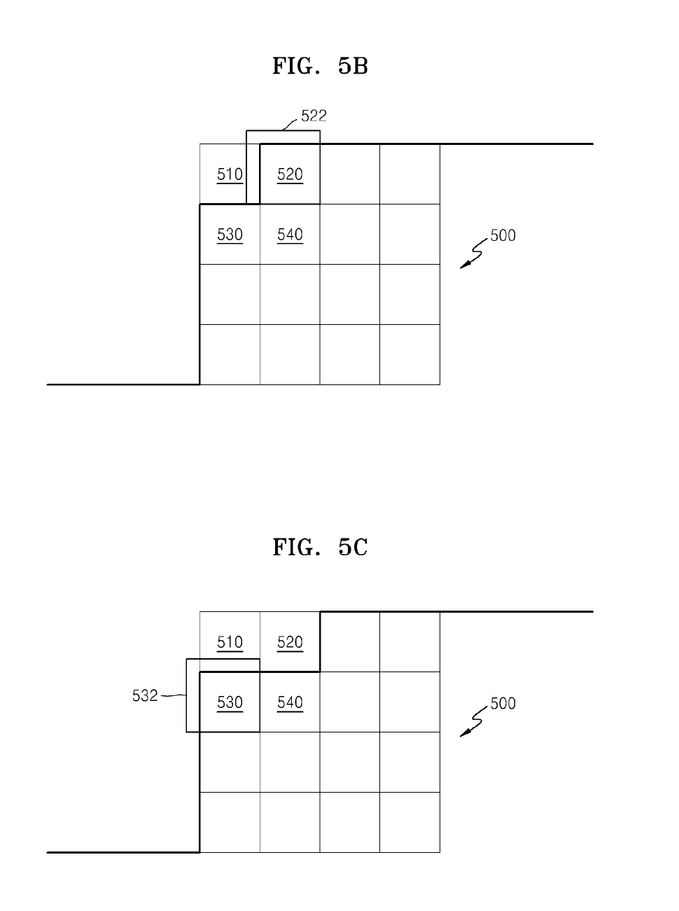

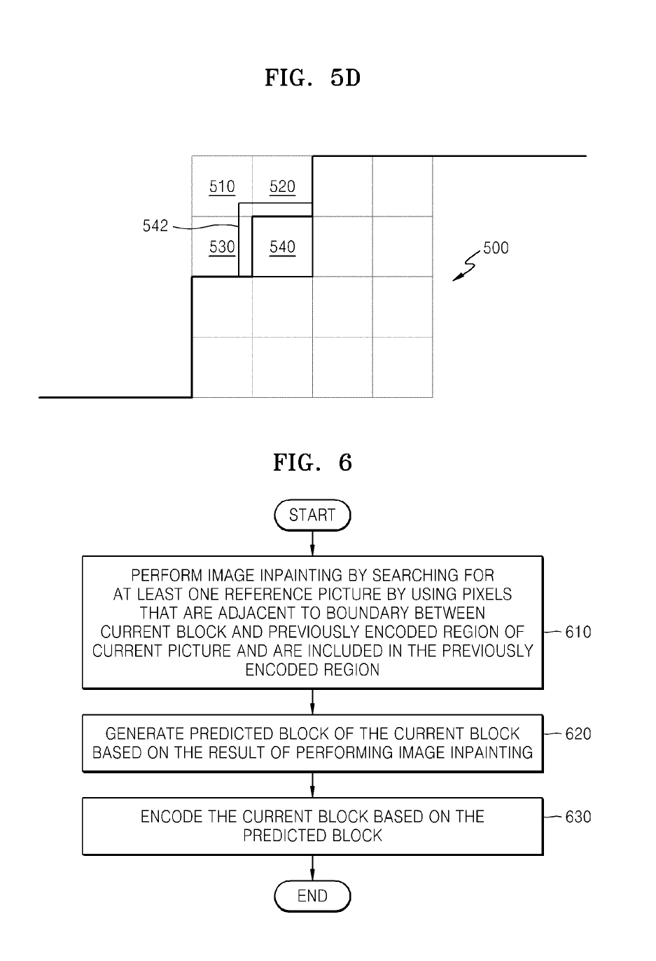

FIGS. 5A through 5D are diagrams sequentially illustrating inter prediction of a macro block 500 according to an exemplary embodiment. FIGS. 5A through 5D respectively illustrate initial boundaries of regions that are to be reconstructed, which are respectively used in performing image inpainting on first through fourth sub blocks 510 through 540 of the macro block 500 in order to inter predict the sub blocks. Here, the size of the macro block 500 is 16×16, and the size of each of the sub blocks is 4×4.

Referring to FIG. 5A, image inpainting is performed on the first block (left-uppermost block) 510 that is to be first encoded from among sub blocks included in the macro block 500, using pixels 512 included in a previously encoded region of a current picture from among a plurality of pixels adjacent to the boundary between the macro block 500 and the previously encoded region. In other words, in order to inter predict the first block 510, the boundary between the macro block 500 and the previously encoded region is used as an initial boundary of a region that is to be reconstructed.

After encoding of the first block 510 is completed, the boundary between the encoded region and a non-encoded region of the current picture is as illustrated in FIG. 5B. Thus, image inpainting is performed on the second block 520 that is to be second encoded from among the sub blocks included in the macro block 500, using pixels 522 adjacent to the boundary between the first and second blocks 510 and 520 and the boundary between the previously encoded region of the current picture and the second block 520.

Likewise, if the sub blocks 520, 530 and 540 are sequentially encoded, the boundary between the encoded region and the non-encoded region of the current picture is sequentially changed as illustrated in FIGS. 5C and 5D. The image encoding apparatus 200 illustrated in FIG. 2, which uses inter prediction, respectively inter predicts the sub blocks 520, 530 and 540 by performing image inpainting based on pixels 522, 532 and 542 adjacent to the changed boundaries.

FIG. 6 is a flowchart illustrating an image encoding method according to an exemplary embodiment. Referring to FIG. 6, in operation 610, the image encoding apparatus 200 illustrated in FIG. 2 performs image inpainting by searching for at least one reference picture by using pixels adjacent to the boundary between a current block and a previously encoded region of a current picture.

Exemplar-based image inpainting described above with reference to FIGS. 4A through 4E is preferably, but not necessarily, performed by setting the boundary between a current block and a previously encoded region as an initial boundary of a region that is to be reconstructed.

In operation 620, the image encoding apparatus 200 generates a predicted block of the current block based on the result of performing image inpainting in operation 610. That is, the predicted block of the current block is generated based on a block reconstructed as the result of performing exemplar-based image inpainting in operation 610.

In operation 630, the image encoding apparatus 200 encodes the current block based on the predicted block generated in operation 620.

A residual block of the current block is generated by subtracting the predicted block from the current block. A discrete cosine coefficient is obtained by performing DCT on the residual block, and the coefficient is quantized. Thereafter, the quantized coefficient is entropy encoded in order to generate a bitstream regarding the current block.

Alternatively, the current block may be encoded according to the skip mode. In the skip mode, the current block is encoded by encoding only encoding mode information representing that the current block has been encoded according to the skip mode, without encoding the residual block.

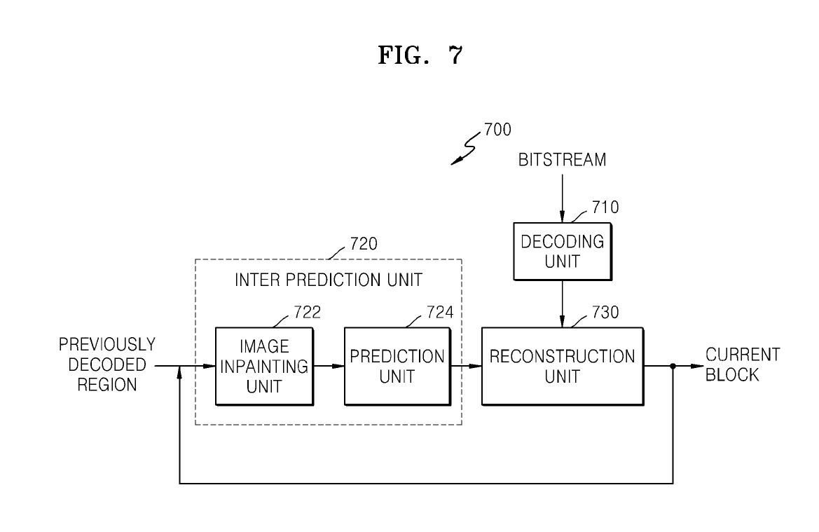

FIG. 7 is a block diagram of an image decoding apparatus 700 according to an exemplary embodiment. Referring to FIG. 7, the image decoding apparatus 700 includes a decoding unit 710, an inter prediction unit 720 and a reconstruction unit 730.

The decoding unit 710 decodes a bitstream regarding a current block. That is, the bitstream regarding the current block is received and entropy decoded. Next, a quantized discrete cosine coefficient of a residual block generated as the result of entropy decoding is dequantized. Then, the residual block is decoded by performing inverse DCT on the dequantized discrete cosine coefficient.

If the current block has been encoded according to the skip mode, the decoding unit 710 extracts the encoding mode information representing that the current block has been encoded according to the skip mode from the bitstream.

Similar to the inter prediction unit 210 of the image encoding apparatus 200 illustrated in FIG. 2, the inter prediction unit 720 generates a predicted block of a current block by performing inter prediction according to an inter prediction method using image inpainting according to an exemplary embodiment. The predicted block of the current block is generated by performing image inpainting by searching for at least one reference picture by using pixels included in a decoded region of a current picture from among pixels adjacent to the boundary between the current block and the previously decoded region.

According to an exemplary embodiment, the inter prediction unit 720 may include an image inpainting unit 722 and a prediction unit 724.

The image inpainting unit 722 performs image inpainting by searching for at least one reference picture by using the pixels adjacent to the boundary between the current block and the previously decoded region. As described above, image inpainting is preferably, but not necessarily, performed by performing exemplar-based image inpainting.

As described above with reference to FIGS. 4A through 4E, the current block is completely reconstructed by setting the boundary between the current block and a previously decoded region of the current picture as an initial boundary of a region that is to be reconstructed and then repeatedly performing image inpainting in units of patches.

The prediction unit 724 generates the predicted block of the current block based on prediction of the image inpainting unit 722.

The reconstruction unit 730 reconstructs the current block based on the predicted block obtained as the result of inter prediction of the inter prediction unit 720.

The current block is reconstructed by combining a residual block decoded by the decoding unit 710 and the predicted block generated by the inter prediction unit 720. If the current block has been encoded according to the skip mode, the current block is reconstructed according to the skip mode. In this case, the predicted block generated by the inter prediction unit 720 is directly used as the current block. The reconstructed block is transmitted to the inter prediction unit 720 so that it can be used in order to predict another block.

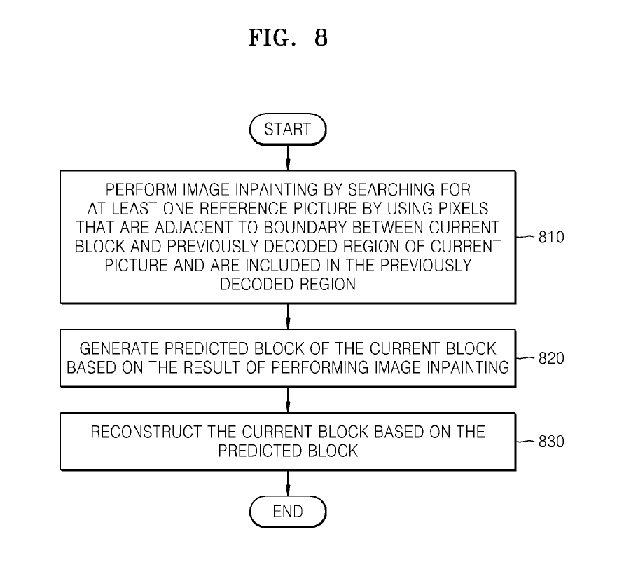

FIG. 8 is a flowchart illustrating an image decoding method according to an exemplary embodiment. Referring to FIG. 8, in operation 810, an image decoding apparatus performs image inpainting by searching for at least one reference picture, based on pixels included in a previously decoded region of a current picture from among pixels adjacent to the boundary between the current block and the previously decoded region.

Exemplar-based image inpainting may be performed based on the pixels adjacent to the boundary between the current block and a previously decoded region of the current picture. The inter prediction method described above with respect to image encoding is also symmetrically applied to image decoding.

In operation 820, the image decoding apparatus generates a predicted block of the current block, based on the result of performing image inpainting in operation 810. The predicted block of the current block is obtained by setting the boundary between the current picture and the previously encoded region as an initial boundary of a region that is to be reconstructed and then repeatedly performing image inpainting in units of patches.

In operation 830, the image decoding apparatus reconstructs the current block based on the predicted block generated in operation 820. The current block is reconstructed by combining a residual block obtained by decoding a bitstream regarding the current block and the predicted block generated in operation 820.

If the current block has been encoded according to the skip mode, the predicted block in operation 820 is directly used as the current block.

The system according to the present invention can be embodied as computer readable code in a computer readable medium. Here, the computer readable medium may be any recording apparatus capable of storing data that is read by a computer system, e.g., a read-only memory (ROM), a random access memory (RAM), a compact disc (CD)-ROM, a magnetic tape, a floppy disk, an optical data storage device, and so on. Also, the computer readable medium may be a carrier wave that transmits data via the Internet, for example. The computer readable medium can be distributed among computer systems that are interconnected through a network, and the present invention may be stored and implemented as computer readable code in the distributed system.

According to the above exemplary embodiments, a current block can be precisely predicted using image inpainting when performing inter prediction, thereby improving the compression rate of image encoding.

While this invention has been particularly shown and described with reference to exemplary embodiments thereof, it will be understood by those skilled in the art that various changes in form and details may be made therein without departing from the spirit and scope of the invention as defined by the appended claims.

1. An inter prediction-based encoding method comprising:
performing image inpainting by searching for at least one reference picture by using pixels that are adjacent to a boundary between a current block and a previously encoded region of a current picture and are in the previously encoded region;
generating a predicted block of the current block based on a result of the performing image inpainting; and
encoding the current block based on the predicted block.

2. The method of claim 1, wherein the encoding of the current block comprises encoding the current block according to a skip mode.

3. The method of claim 1, wherein the performing of image inpainting comprises performing exemplar-based image inpainting by searching for the at least one reference picture by using the pixels that are adjacent to the boundary between the current block and the previously encoded region of the current picture and are in the previously encoded region.

4. The method of claim 3, wherein the performing of exemplar-based image inpainting comprises:
(a) setting the boundary between the current block and the previously encoded region of the current picture as a boundary of a region that is to be reconstructed;
(b) selecting a pixel having a highest priority to be reconstructed from among the pixels adjacent to the boundary of the region that is to be reconstructed;
(c) searching the at least one reference picture for a second patch similar to a first patch including the selected pixel;
(d) reconstructing a part of the current block based on a result of searching in (c);
(e) updating the boundary of the region that is to be reconstructed, based on a result of reconstructing in (d); and
(f) repeatedly performing (b) through (e) until the current block is completely reconstructed.

5. The method of claim 4, wherein a size of the first and the second patches is 3×3, 5×5 or 7×7.

6. An inter prediction-based encoding apparatus comprising:
an image inpainting unit which performs image inpainting by searching for at least one reference picture by using pixels that are adjacent to a boundary between a current block and a previously encoded region of a current picture and are included in the previously encoded region;
a prediction unit which generates a predicted block of the current block based on a result of performing image inpainting; and
an encoding unit which encodes the current block based on the predicted block.

7. The apparatus of claim 6, wherein the encoding unit encodes the current block according to a skip mode.

8. The apparatus of claim 6, wherein the image inpainting unit performs exemplar-based image inpainting by searching for the at least one reference picture by using the pixels that are adjacent to the boundary between the current block and the previously encoded region of the current picture and are in the previously encoded region.

9. An inter prediction-based decoding method comprising:
performing image inpainting by searching for at least one reference picture by using pixels that are adjacent to a boundary between a current block and a previously decoded region of a current picture and are in the previously decoded region;
generating a predicted block of the current block based on a result of performing image inpainting; and
reconstructing the current block based on the predicted block.

10. The method of claim 9, wherein the reconstructing of the current block comprises reconstructing the current block according to a skip mode.

11. The method of claim 9, wherein the performing of image inpainting comprises performing exemplar-based image inpainting by searching for the at least one reference picture by using the pixels that are adjacent to the boundary between the current block and the previously decoded region of the current picture and are in the previously decoded region.

12. The method of claim 11, wherein the performing of the exemplar-based image inpainting comprises:
(a) setting the boundary between the current block and the previously decoded region of the current picture as a boundary of a region that is to be reconstructed;
(b) selecting a pixel having highest priority to be reconstructed from among the pixels adjacent to the boundary of the region that is to be reconstructed;
(c) searching the at least one reference picture for a second patch similar to a first patch including the selected pixel;
(d) reconstructing a part of the current block based on a result of searching in (c);
(e) updating the boundary of the region that is to be reconstructed based on a result of reconstructing in (d); and
(f) repeatedly performing (b) through (e) until the current block is completely reconstructed.

13. The method of claim 12, wherein a size of the first and the second patches is 3×3, 5×5 or 7×7.

14. A decoding apparatus based on inter prediction, the apparatus comprising:
an image inpainting unit which performs image inpainting by searching for at least one reference picture by using pixels that are adjacent to a boundary between a current block and a previously decoded region of a current picture and are in the previously decoded region;
a prediction unit which generates a predicted block of the current block based on a result of performing image inpainting; and
a reconstruction unit which reconstructs the current block based on the predicted block.

15. The apparatus of claim 14, wherein the reconstruction unit reconstructs the current block according to a skip mode.

16. The apparatus of claim 14, wherein the image inpainting unit performs exemplar-based image inpainting by searching for the at least one reference picture by using the pixels that are adjacent to the boundary between the current block and the previously decoded region of the current picture and are in the previously decoded region.

17. A computer readable medium having recorded thereon a computer program for executing the method of claim 1.

18. A computer readable medium having recorded thereon a computer program for executing the method of claim 9.
